(19) United States
(12) Patent Application Publication
(10) Pub. No.: US 2026/0048807 A1
(43) Pub. Date: Feb. 19, 2026

(54) Camera Mount for Motorcycle Suspension

(71) Applicants: Erich Wilhelm Strub, Escondido, CA (US); Vance Hiroshi Lund, Valley Center, CA (US)

(72) Inventors: Erich Wilhelm Strub, Escondido, CA (US); Vance Hiroshi Lund, Valley Center, CA (US)

(21) Appl. No.: 18/806,067

(22) Filed: Aug. 15, 2024

(51) Int. Cl. B62J 45/42; B62J 45/41; G07C 5/02

(52) U.S. Cl. CPC B62J 45/42; B62J 45/41; G07C 5/02

(57) ABSTRACT

An apparatus and methods are provided for a camera mount to attach to a motorcycle, allowing for a forward-facing perspective to record the motorcycle's suspension. Camera mount is affixed to motorcycle utilizing existing fastener features of the motorcycle's engine and/or chassis.

### FIELD OF INVENTION

The embodiments of the present disclosure generally relate to a camera mount to record motorcycle suspension, but is not limited to the camera mount of the kind illustrated. More specifically, embodiments of the disclosure relate to an apparatus and methods for a camera mount to affix to motorcycle's engine using existing fastener features and/or motorcycle's chassis, allowing for a forward-facing perspective for a camera to record the motorcycle's suspension during riding session.

### BACKGROUND OF THE INVENTION

Motorsport as a whole has always been a massive contributor to innovation. Competitive evolution to build the vehicles better, faster, and stronger relate primarily back to R&D and testing. During development and testing of vehicles, data and feedback are essential.

The dynamic nature of a motorcycle's suspension has traditionally been tuned through subjective rider feedback, as well as but not limited to, subjective spectator feedback.

The terrain, especially with off-road, has extreme variation of desert to mountains, sand, mud, clay, rocks. The same motorcycle will have the suspension settings adjusted completely different in order to adapt to the present conditions.

Track or terrain surface conditions, rider skill, and vehicle setup all combine during testing, and subjective feedback can be difficult to quantify or relate to tuning.

Incorporating a camera to record the suspension behavior, as well as the terrain the motorcycle is traversing, can provide unbiased video documentation of the riding or test session.

As cameras, and specifically the “action cameras,” continue to improve year-over-year, with image stabilization, as well as ever increasing video resolution and frame-rate, the camera is a very useful tool in testing, documentation, and quantification of data. This footage may also be analyzed with computer software to track the suspension movement and extrapolate suspension position, travel speed, and acceleration.

### OUTLINE OF THE INVENTION

The present invention refers to a camera mount, composed of a mounting plate with a camera base mount, that allows for easy attachment to the motorcycle using existing engine and/or chassis fastener features.

An action-style camera engages with base mount to be secured to the motorcycle and aimed at the suspension.

This perspective has not yet been incorporated into test riding for recorded visual feedback. The recorded footage is a new perspective to observe motorcycle suspension behavior across terrain.

The recorded footage serves as data that can be used for, but is not limited to, subjective and analytic review purposes. A subjective analysis of footage by an experience individual can provide great insight to the current suspension behavior, and allow for educated improvements to suspension settings. Considering computer-aided video analysis, two visual targets can be used, such as QR codes, that are affixed to the suspension top (static position) and bottom (dynamic position, corelating with fork travel) allow for computer software to analyze footage and extrapolate data (fork position or “stroke”, fork velocity, fork acceleration) from the video frames by comparing the relative position of the moving target against the static target across time. The recorded footage, and any extrapolated data, serves as a catalogue for comparative analysis.

The recorded footage, due to its unique perspective, also allows for, but is not limited to artistic and advertising purposes.

### BRIEF DESCRIPTION OF DRAWINGS

The accompanying drawings illustrate the preferred embodiment of the invention wherein:

FIG. 1 is a complete camera mount (1), consisting of mounting plate (2), and camera base mount pad (3) for action-style camera. Additional hole (4) allows for optional safety cable to tether camera to plate, in the event of base mount pad (3) failure.

FIG. 2 is an exploded view of unique attachment style of the camera mount to motorcycle engine (5) using two existing fastener features (10), and camera (8) with a quick-release base (9) allowing slide-action engagement into base mount (3). Engine intake (6) is assumed rear, engine exhaust port (7) is assumed front, engine stator cover (11) is assumed left-side, and this orientation is overwhelmingly the general convention for most manufacturers of motocross-style motorcycles.

FIG. 3 is a common 2-stroke exhaust routing (12) to the right side of motorcycle. This is the general convention of most motocross-style motorcycles.

FIG. 4 is a common 4-stroke exhaust (13) routing to right side of motorcycle. This is the general convention of most motocross-style motorcycles.

FIG. 5 illustrates Camera (8) left side of motorcycle placement to avoid excessive heat from exhaust system and is forward facing to view and record the front suspension of motorcycle reacting with oncoming terrain as well as optional visual targets affixed to the static top of suspension fork (14) and dynamic bottom of fork (15).

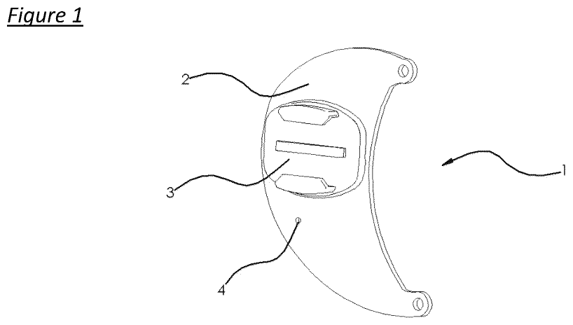

### METHOD OF PERFORMANCE

Referring to the drawings, there is illustrated a complete camera mount (1) comprised of a mounting plate (2) with a camera base (3) that is affixed to a motorcycle using existing fastener features (10) of the engine (5). Mounting plate (2) and camera base (3) may be manufactured from a variety of materials including, but not limited to metallic, composite or plastic. Assuming common material for mounting plate (2) and camera base (3), camera mount (1) may be manufactured as a singular part.

FIG. 5 illustrates Camera (8) left side of motorcycle placement and is forward facing to view and record the front suspension of the motorcycle reacting with oncoming terrain. The use of visual targets (i.e. QR code) at the static top of the fork (14) and the dynamic bottom of the fork (15) increase the accuracy of computer aided analysis of footage to quantify fork position or “stroke”, fork velocity, and fork acceleration data.

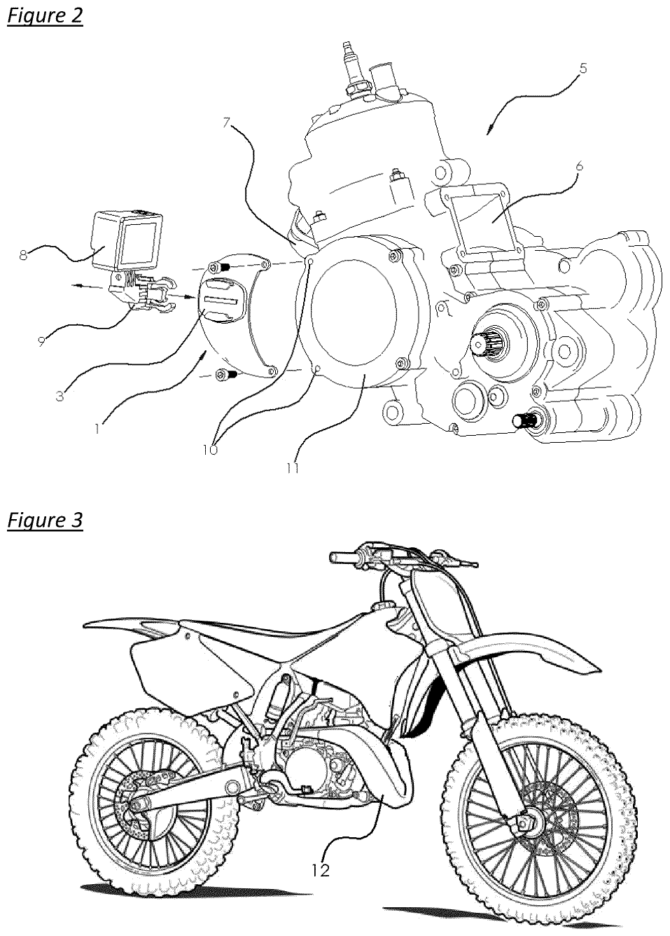

FIG. 2 illustrates Camera (8) can be taken on and off motorcycle using existing quick-release base (9) that slide-engages with camera base (3). Exhaust port (7) is assumed the front of engine, intake port (6) is assumed the rear of engine, and stator cover (11) is assumed left-side of motorcycle.

Profile of mounting plate (2) has design considerations such that camera base (3) will offer an ideal forward-viewing position for camera (8), avoid excessive heat, and capture fastener features (10) for fixation to motorcycle.

An additional smaller hole (4) is added to mounting plate (2) for the purpose of an optional safety cable to tether camera (8) to the fixed plate, in the event camera base (3) should fail.

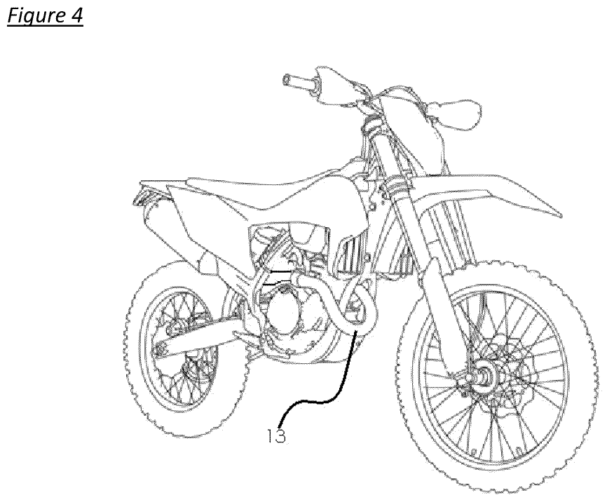

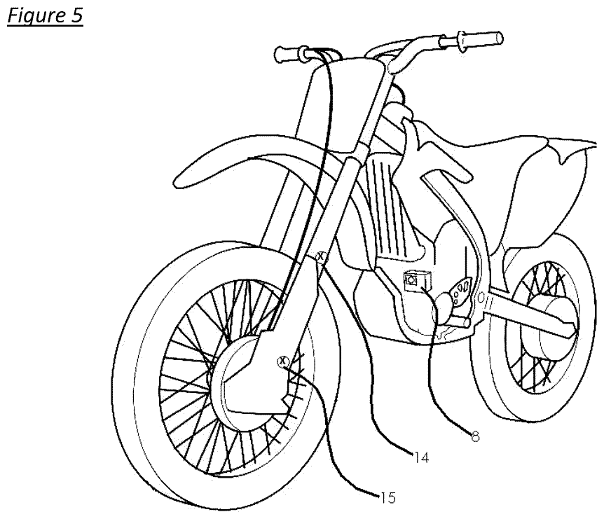

Left or right-side attachment of camera mount to motorcycle is favored opposite of exhaust to avoid excessive heat exposure to camera. The overwhelming design convention of motocross-type motorcycles route the exhaust to the right side of vehicle. FIG. 3 illustrates a common 2-stroke exhaust (12) routing to right side of motorcycle, exiting at rear fender. FIG. 4 illustrates a common 4-stroke exhaust (13) routing to the right side of motorcycle, exiting at rear fender. FIG. 2 illustrates a common attachment of camera mount to left side case/stator cover (11) with fastener features (10), to avoid right side exhaust routing.

The embodiments of the present disclosure and descriptions specified here are a general representation of the present invention, and that numerous variations of engine and chassis design between motorcycle manufactures can affect the profile shape of mounting plate (2) and location of available existing fasteners (10).

Regardless of these variations between different motorcycle models, the overall intent of invention use, and the invention design intent of camera (14) placement with capturing existing fastener features (10) for fixation, remain apparent without departing from the ambit and scope of the invention as set out in the appended claims.

### SUMMARY

An apparatus and methods are provided to affix a camera mount to a motorcycle's engine using existing fastener features and/or motorcycle chassis for the purpose of allowing quick attachment of camera to the mount in a forward-facing orientation to record the motorcycle's suspension during a riding or test session. The recorded footage of the suspension behavior can then be subjectively examined for the purposes of confirming optimal settings and behavior, or to make directional changes. The footage serves as a catalogue for comparison. The use of visual targets, such as QR codes, attached at the static top of the fork leg and the dynamic bottom of the fork leg, allows for computer-aided software to more accurately extrapolate meaningful physical motion data. The useful data to record are instantaneous fork position, fork travel velocity, and fork acceleration. This data is quantifiable, and allows for directional changes to suspension settings, along with the subjective rider feedback. Utilization of a camera for the purpose of data and video collecting, along with the unique attachment style, has not been implemented in the world of off-road motorcycles. As cameras increase in recording capability, the usefulness of this invention increases as well.

1. The camera mount comprising a simple plate of metallic, composite, or plastic material with a camera base mount, that is uniquely affixed to the motorcycle utilizing existing fastener features of the motorcycle's engine case and/or chassis.

2. The camera mount according to claim 1 wherein the design incorporates an ideal camera position with existing fastener features of the motorcycle.

3. The camera mount according to claim 1 wherein the recorded footage can be used for, but is not limited to, subjective visual analysis of suspension behavior.

4. The camera mount according to claim 1 wherein the recorded footage can be used for, but is not limited to, computer-aided analysis of suspension position, velocity, acceleration.

5. The camera mount according to claim 1 wherein the recorded footage can be used for, but is not limited to riding documentation.

6. The camera mount according to claim 1 wherein the recorded footage can be used for, but is not limited to, artistic and advertising purposes such as film edits, and/or photography.

7. The camera mount according to claim 1 wherein the left or right-side of motorcycle attachment is determined to avoid excessive heat from exhaust header, and is favored on opposite side of exhaust routing.

8. The camera mount according to claim 1 wherein an additional smaller hole is added to the plate for the purpose of an optional safety cable to tether the camera to the fixed plate, should the camera base fail.
